(19) United States
(12) Patent Application Publication
(10) Pub. No.: US 2015/0134555 A1
(43) Pub. Date: May 14, 2015

(54) DOCUMENT ERROR RESOLUTION

(71) Applicant: Tracker Corp, San Francisco, CA (US)

(72) Inventors: Brian Fancher, Oakland, CA (US); Julie Pearl, Woodside, CA (US)

(73) Assignee: Tracker Corp, San Francisco, CA (US)

(21) Appl. No.: 14/533,005

(22) Filed: Nov. 4, 2014

Related U.S. Application Data
(60) Provisional application No. 61/902,060, filed on Nov. 8, 2013.

(51) Int. Cl. G06Q 10/10

(52) U.S. Cl. CPC G06Q 10/1053; G06Q 10/10
USPC 705/321; 705/342

(57) ABSTRACT

Described herein are techniques and mechanisms for document error resolution. According to various embodiments, errors in existing document record data associated with an existing document record may be identified. The existing document record may be associated with a digital image of a physical document, which may be associated with one or more document restrictions. Replacement data may be determined for resolving one or more of the identified errors, and the replacement data may be stored on a storage medium.

### CROSS-REFERENCE TO RELATED APPLICATIONS

The present application claims priority to Provisional U.S. Patent App. No. 61/902,060 (Attorney Docket No. TRCKP001P) by Brian Fancher, filed Nov. 8, 2013, which is incorporated herein in its entirety and for all purposes.

### TECHNICAL FIELD

The present disclosure relates generally to computer systems configured to resolve errors in form documents, and more specifically to the resolution of errors in U.S. government employment documents.

### DESCRIPTION OF RELATED ART

Various documents and forms may be used to record and present information in a structured and organized way. For example, the Employment Eligibility Verification Form I-9 (I-9 Form) is a U.S. Citizenship and Immigration Services form that is used by an employer to verify an employee's identity and to establish that the worker is eligible to accept employment in the United States. The I-9 Form is available from the U.S. Department of Homeland Security, U.S. Citizenship and Immigration Services Division. The I-9 Form is hereby incorporated by reference in its entirety and for all purposes.

Many documents and forms are associated with restrictions, requirements, or guidelines that govern their use. For example, a form may be associated with a requirement that a modification to a signed form be initialed by the person making the change. As another example, a form may be associated with a requirement that the person whose information is described on the form present documentary evidence such as a picture ID that corroborates the information included on the form before the form is signed and/or notarized.

In the context of employment, The Immigration Reform and Control Act of 1986 (IRCA) required employers to verify that all newly hired employees present “facially valid” documentation verifying the employee's identity and legal authorization to accept employment in the United States. The I-9 form is provided by the federal government for that purpose. Completion of an I-9 Form at the time of hiring is required for employees hired after Nov. 6, 1986. The I-9 form is associated with various requirements and restrictions. For example, some portions of the I-9 form must be completed by the employer, while other portions of the I-9 must be completed by the employee. As another example, the employer is responsible for ensuring that the forms are completed properly, and in a timely manner. As yet another example, if an employee cannot read or cannot write English, a translator or preparer may complete the form and sign it, in addition to the employee's own signature.

### SUMMARY

The following presents a simplified summary of the disclosure in order to provide a basic understanding of certain embodiments of the invention. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

In general, certain embodiments of the present invention provide mechanisms for document error resolution. According to various embodiments, a document record processor may identify one or more errors in existing document record data associated with an existing document record. The existing document record may be associated with a digital image of a physical document and/or with one or more document restrictions. A document error resolver may determine replacement data for resolving one or more of the identified errors, and a storage medium may store the replacement data.

According to various embodiments, a physical document may be scanned to create the digital image. Optical character recognition may be performed on the digital image to identify the existing document record data.

According to various embodiments, the document record may correspond with an official government record, which may be an Employment Eligibility Verification Form I-9 provided by United States Citizenship and Immigration Services.

According to various embodiments, identifying errors in the existing document record data may involve applying data validation rules to the existing document record data. The data validation rules may be used to indicate violations of the document restrictions.

According to various embodiments, a determination may be made that the document record is not remediable. A new document record including at least a portion of the existing document record data and/or the replacement data may be created.

According to various embodiments, the document record may be associated with a unique visual record identifier and transmitted to the document subject for completion. A completed document including the unique visual record identifier may be received from the document subject and associated the completed document with the document record based on the visual record identifier.

According to various embodiments, determining replacement data may involve receiving user input to resolve one or more errors and associating the received user input with a user account.

### BRIEF DESCRIPTION OF THE DRAWINGS

The disclosure may best be understood by reference to the following description taken in conjunction with the accompanying drawings, which illustrate particular embodiments of the present invention.

FIG. 1 illustrates an example of a document data record creation method, performed in accordance with one or more embodiments.

FIG. 2 illustrates an example of a document record data validation method.

FIG. 3 illustrates an example of a document record data resolution method.

FIG. 4 illustrates an example of a document data record error analysis method.

FIG. 5 illustrates an example of a document record creation method.

FIGS. 6-23 illustrate various user interfaces that may be presented in accordance with techniques and mechanisms described herein.

FIG. 24 illustrates one example of a server, configured in accordance with one or more embodiments.

### DESCRIPTION OF PARTICULAR EMBODIMENTS

Reference will now be made in detail to some specific examples of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims.

For example, some of the techniques of the present invention will be described in the context of Form USCIS 19 titled Instructions for Employment Eligibility Verification. However, it should be noted that the techniques of the present invention apply to a wide variety of different documents and communications. In the following description, numerous specific details are set forth in order to provide a thorough understanding of the present invention. Particular example embodiments of the present invention may be implemented without some or all of these specific details. In other instances, well known process operations have not been described in detail in order not to unnecessarily obscure the present invention.

Various techniques and mechanisms of the present invention will sometimes be described in singular form for clarity. However, it should be noted that some embodiments include multiple iterations of a technique or multiple instantiations of a mechanism unless noted otherwise. For example, a system uses a processor in a variety of contexts. However, it will be appreciated that a system can use multiple processors while remaining within the scope of the present invention unless otherwise noted. Furthermore, the techniques and mechanisms of the present invention will sometimes describe a connection between two entities. It should be noted that a connection between two entities does not necessarily mean a direct, unimpeded connection, as a variety of other entities may reside between the two entities. For example, a processor may be connected to memory, but it will be appreciated that a variety of bridges and controllers may reside between the processor and memory. Consequently, a connection does not necessarily mean a direct, unimpeded connection unless otherwise noted.

Overview

Many organizations with large hiring volumes are adopting electronic I-9 and E-Verify solutions to replace non-compliant and inefficient paper processes for new hires. However, since a Notice of Inspection from the U.S. Citizenship and Immigration Services will not be limited to recent hires, an organization's existing I9s pose a considerable risk. Many previously-completed paper I-9 forms include at least one error, many of which may expose a company to fines by the federal government. Techniques and mechanisms described herein facilitate the remediation of existing paper and electronic I9s and aid in ensuring legal compliance with I9s Form regulations and requirements. Techniques and mechanisms described herein also facilitate the proper completion of forms and documents such as the I-9 Form. For instance, techniques and mechanisms described herein facilitate the identification of errors in I-9 Forms and other documents as well as the resolution of some or all of those errors.

### Example Embodiments

In some embodiments, historical I-9 Forms may be migrated to electronic versions. Paper I-9 Forms may be converted into electronic format by using a scan and key service. Alternately, or additionally, paper I-9 Forms may be converted via manual entry or uploading from other digital systems.

According to various embodiments, historical I-9 Form records may be brought up-to-date with information from an HR system of record such as the employee's current manager and worksite, termination information if applicable, and employee data verification information. Updating historical I-9 Forms may help to ensure that re-verification notices are sent to the correct person and/or that records are automatically flagged for purging according to schedule.

According to various embodiments, historical I-9 Forms may be electronically submitted for verification without re-keying data. Verification submissions, responses, and subsequent actions may be tracked. After migration, historical I-9 Forms may be securely stored and access in a digital format, and corresponding paper I-9 Forms can be destroyed.

According to various embodiments, compliance violations on historical I-9 Forms may be identified and prioritized. For instance, compliance violations may be identified with an automated analysis of historical records. Several versions of the I-9 Form have existed over time. Compliance logic can take into consideration the version of I-9 Form that should have been used given a specific hire date and apply rules that were in place for that version.

According to various embodiments, I-9 Forms that need attention may be identified. For instance, non-compliant I-9 Forms may be marked, with violations flagged and annotated. The various contributors to non-compliance may be identified. For instance, reports that show where errors are occurring and the frequency of each type of error may be created.

In some embodiments, I-9 Form analysis may facilitate the determination of overall audit exposure and allow the prioritization of I-9 Form cleansing efforts based on special remediation reports. For instance, the most costly errors to address may be identified for prioritized resolution. Alternately, or additionally, errors may be identified by any other grouping such as by I-9 Form section, worksite, or hiring manager. Then, I-9 Form cleansing work may be allocated according to business needs. Progress of each group of I-9 Form cleansing may be tracked with reports that describe the progression.

According to various embodiments, techniques and mechanisms described herein may facilitate the remediation of I-9 records that have errors. For example, I-9 requirement violations may be identified and clearly marked in a user interface. Then, guidance on corrective steps for addressing the violations may be provided.

In some embodiments, input related to corrective actions may be validated, providing assurance that changes are compliant. The remediation process may be streamlined by limiting edit access to those fields in error, keeping compliant data locked down. Evidence of good-faith compliance may be shown for violations that cannot be cured or that are difficult to cure. For instance, audit notes that explain the problem and actions taken to prevent it from happening in the future may be entered. Prompts to create a new I-9 record may be provided when errors cannot be corrected, potentially increasing the efficiency and compliance of I-9 cleansing efforts.

In some implementations, historical I-9 Forms may be prepared for audit. Automated logs may describe changes to fields and records. Alternately, or additionally, copies of signed I-9 Form versions may be stored and retrieved upon request. For instance, historical I-9 Forms may be retrieved in response to a U.S. Immigration and Customs Enforcement (ICE) audit or other type of audit.

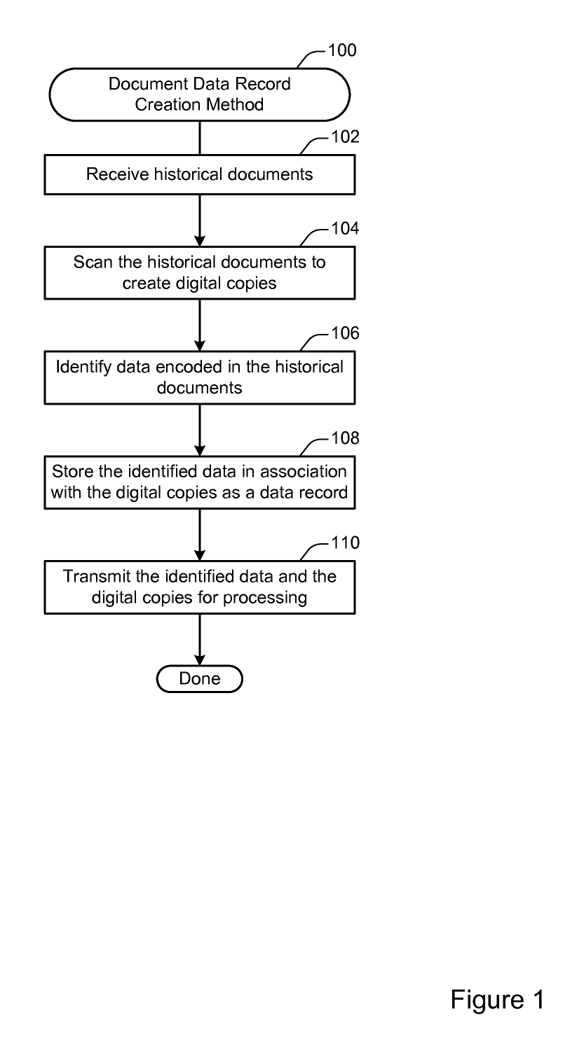

FIG. 1 illustrates an example of a document data record creation method 100, performed in accordance with one or more embodiments. At 102, historical documents are received. The historical documents may be transmitted in a digital or paper format. The historical documents may be, for instance, paper copies of I-9 Forms. At 104, the historical documents are scanned to create digital copies if they are not yet in a digital format.

At 106, data encoded in the historical documents is identified. For example, a human may review the historical documents and enter the information in the historical documents into a digital format. As another example, optical character recognition techniques may be used to convert information encoded in the historical documents to a digital format.

At 108, the identified information is stored in association with the digital copies. According to various embodiments, the identified information may be stored in a standardized format. For instance, an I-9 Form may have an employment initiation date field for entering the date on which an employee's period of employment begins. The information entered in this field on an I-9 Form may be identified at operation 106 and stored in a standardized digital format in operation 108. In this way, the information is available for access via search queries or other digital access techniques.

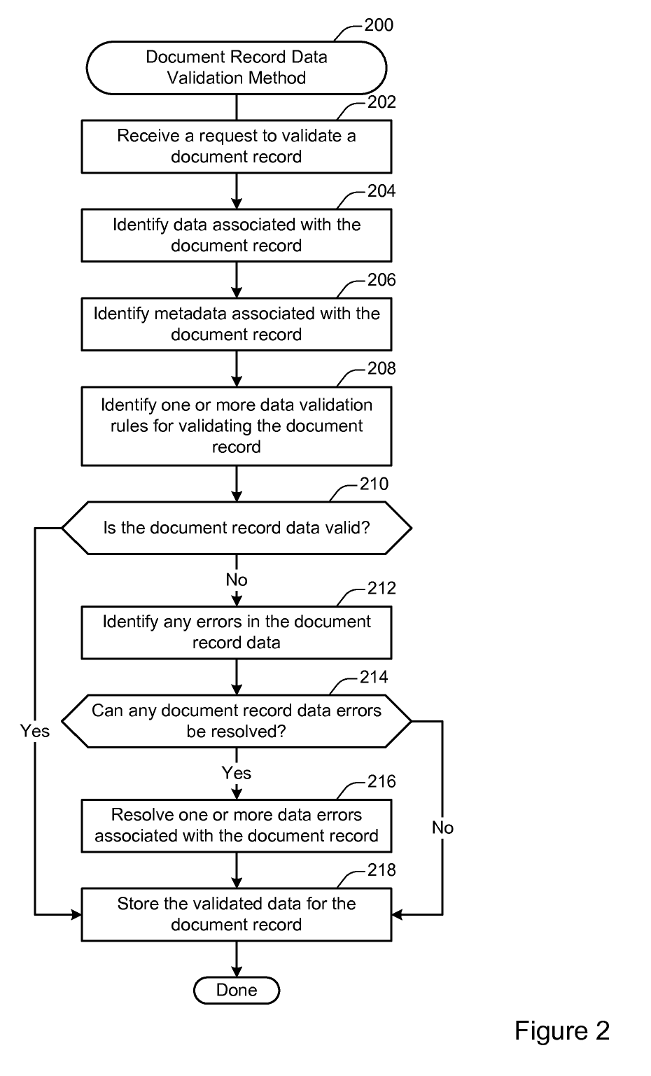

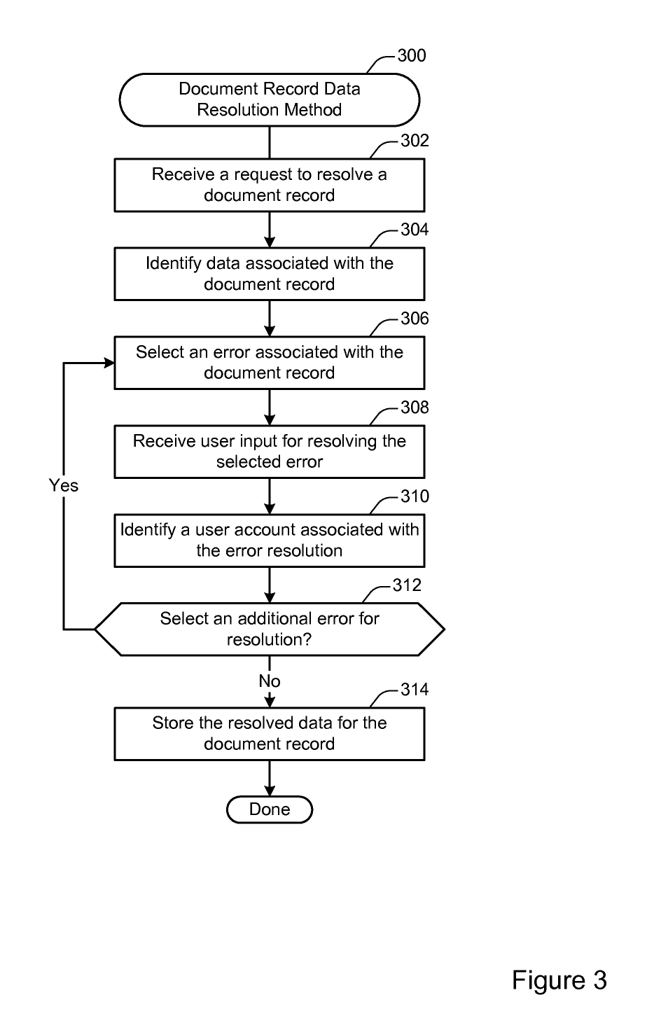

At 110, the identified data and the digital copies are transmitted for processing. For instance, the information may be processed as described with respect to methods 200 and 300 discussed with respect to FIGS. 2 and 3.

FIG. 2 illustrates an example of a document record data validation method 200, performed in accordance with one or more embodiments. According to various embodiments, the method 200 may be performed for a document such as an I-9 Form. For instance, the method 200 may be performed for an I-9 Form that has been processed as described with respect to the method 100 shown in FIG. 1. The method 200 may be used to ensure that the data encoded in the document meets one or more requirements or restrictions associated with the document. For instance, federal laws and regulations specify many different rules related to the procedure and content for providing I-9 Form information.

At 202, a request to validate a document is received. For instance, the request may be generated for an I-9 Form document processed as described with respect to method 200. At 204, data associated with the document is identified. For example, the data may be information encoded in the document identified as described with respect to operation 106, stored as described with respect to operation 108, and transmitted as described with respect to operation 108. In the case of an I-9 Form, the data identified may include any information encoded in the I-9 form such as the name of an employee, the employee's start date, or other such employment data.

At 206, metadata associated with the document record data is identified. According to various embodiments, the metadata may be information identified as being potentially useful to validate and/or correct information associated with the document record. For instance, in the case of I-9 Form document records, the employer may provide employment data that may be used to determine whether the information included in I-9 Form document records is correct. If an I-9 Form document record is missing data or has other errors, then in some instances the employer-provided employment data may be used to supplement the document record data and/or resolve the errors.

At 208, one or more data validation rules for validating the document record is identified. According to various embodiments, different types of document records may be associated with different rules and restrictions that govern the information included in the document records. For some documents, these rules and restrictions may be specified in a digital format so that they can be applied to the document to determine whether the information associated with the document record is valid. For instance, in the case of an I-9 Form record, an employer may be required to complete the I-9 Form within three business days after an employee's term of employment begins.

At 210, a determination is made as to whether the document record data is valid. According to various embodiments, the determination may be made by determining whether the data associated with the document record identified at operation 204 complies with the one or more data validation rules identified at operation 206. For example, as discussed above, an employer may be required to complete an I-9 Form within three business days after an employee's term of employment begins. Accordingly, the system may determine whether the data associated with the document record includes both a date that employment was commenced and a date on which the I-9 Form associated with the I-9 record was completed. If both dates exist and the second date is within three business days of the first date, then the rule may be satisfied. Otherwise, the I-9 record may be identified as having an error. As another example, the determination may be made at least in part by comparing metadata associated with the document record identified at operation 206 with the data associated with the document record identified at operation 204.

At 212, any errors in the document record data are identified. According to various embodiments, errors may be identified based on data that violated a validation rule identified in operation 206. For example, when the determination is made as to whether the document record data is valid, any data that is missing or inconsistent may be flagged as an error. As another example, any data that violates a data validation rule may be flagged as an error.

At 214, a determination may be made as to whether any document record data errors can be resolved. For instance, some errors identified at operation 206 may be resolvable via supplemental metadata and/or business logic. However, other errors may not be resolvable. For example, data associated with a name field or other key identifiers associated with the document may be missing or illegible, in which case a new document record may need to be created.

At 216, one or more data errors associated with the data record are resolved. According to various embodiments, data errors may be resolved in any of a variety of ways. For example, missing data associated with a document record may be supplemented with metadata. As another example, business logic rules may be used to correct errors. For instance, in the case of I-9 Form document records, each document record may include both a data field that identifies a type of identification record provided by an employee as well as an issuing authority for the identification record. If the identification record is described in the data as a “U.S. passport” but the issuing authority is omitted in the data, then business logic may be used to resolve the issuing authority as “The U.S. Department of State”.

At 218, the validated data for the document is stored. For instance, the validated data may be stored along with the initial data identified at operation 204 and the digital copy of the document created at operation 104. The information may be stored for retrieval and/or for further processing, for instance in conjunction with the method 300 shown in FIG. 3. The information may identify, for instance, data fields that have no errors, data fields that have been automatically resolved, and data fields with errors that have not been resolved.

FIG. 3 illustrates an example of a document record data resolution method 300, performed in accordance with one or more embodiments. According to various embodiments, the method 300 may be performed in order to resolve one or more errors associated with a document data record. For instance, one or more errors in an I-9 Form document record may be identified. As discussed with respect to FIG. 2, some errors may be identified via an automatic resolution procedure. Other errors may be resolved with assistance from a user.

At 302, a request to resolve a document record is received. According to various embodiments, the request may identify a document record that has been determined to have one or more errors, for instance via the document record data validation method described with respect to FIG. 2.

At 304, data associated with the document record is identified. The data may include any information related to the document record, such as data encoded in a document, a digital copy of a document, corrected data, and/or document metadata.

At 306, an error associated with the document record is selected. For instance, the selected error may be identified as part of a data validation process as discussed with respect to FIG. 2.

At 308, user input for resolving the selected error is received. According to various embodiments, different types of user input may be received for resolving different types of errors. For example, a user may provide data that is missing in a document data record. As another example, a user may indicate which of two inconsistent fields in a data record is correct. As yet another example, a user may enter a textual explanation regarding the reason for or source of a particular error. For instance, some errors may not be resolvable. However, a user may explain the cause of the error and/or describe any efforts made to correct the error or prevent similar errors in the future.

At 310, a user account associated with the error resolution is identified. According to various embodiments, user input used to resolve errors in a document record may be associated with a user account that identifies a user. In this way, changes to a document record may be attributed to a user. For instance, some types of documents are associated with rules that require document changes to be linked to an individual responsible for the change.

At 312, a determination is made as to whether to select an additional error for resolution. According to various embodiments, a document may be identified with any number of errors, and some or all of these errors may be selected for resolution. For instance, errors may be selected for resolution based on user input in a user interface.

At 314, the resolved data for the document record is stored. According to various embodiments, the data may be stored in a data storage system such as a database. The data may be stored in such a way that it may be retrieved, for instance in the event of an audit of the document record. For example, a resolved data record may be associated with a digital copy of the document, the original data encoded in the document, metadata used to automatically resolve document errors, user input provided by a user to correct or explain document errors, and any other information related to the document record. In this way, the document record may be presented in a “before and after” format in the event of an audit.

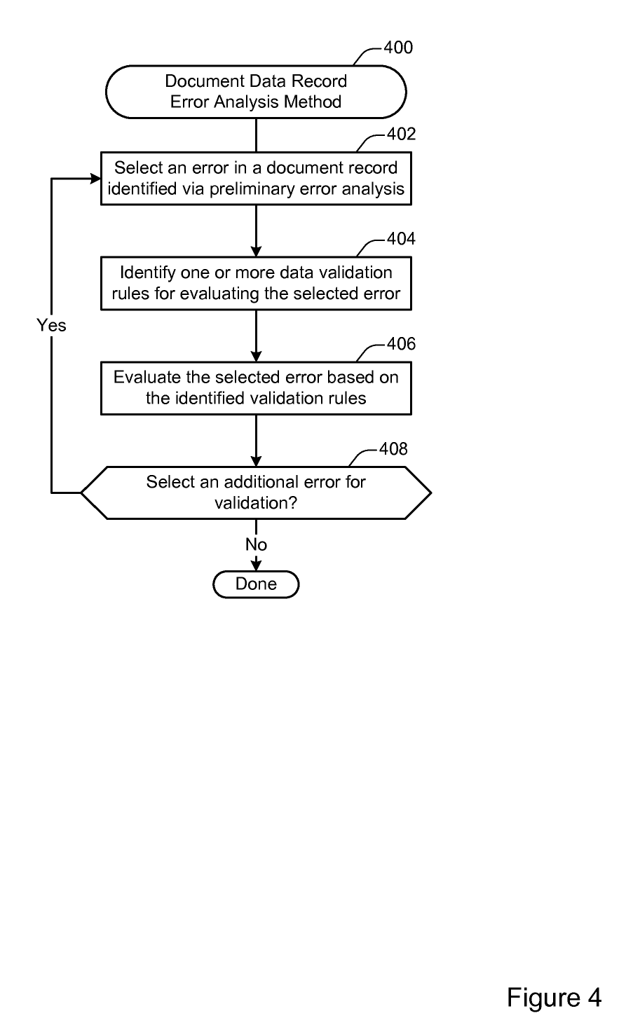

FIG. 4 illustrates an example of a document data record error analysis method 400, performed in accordance with one or more embodiments. In some implementations, the method 400 may be performed in order to evaluate the validity of an error identified via preliminary error analysis. For instance, operations shown in method 400 may be performed in conjunction with operations shown in the methods 100, 200, and 300 described with respect to FIGS. 1-3.

At 402, an error in a document record is selected. According to various embodiments, the error may be identified via preliminary error analysis. For example, the error may be identified by a user. For instance, the user may manually enter document record information based on a document. Alternately, the user may review document record information identified via automatic techniques such as optical character recognition. When the user identifies a likely error, the user may indicate the error in association with the document record data.

As another example, the error may be identified via an automatic preliminary error analysis technique. For instance, when data is entered into the system, preliminary error analysis techniques may be used to identify basic errors such as missing or invalid data (e.g., an invalid date).

At 404, one or more data validation rules for evaluating the selected error is identified. According to various embodiments, each data validation rules may designate one or more criteria for identifying an error. The criteria may be used to categorize and identify errors more precisely than in the preliminary analysis. The more specific errors identified based on the validation rules may be referred to herein as “advanced” errors.

In some implementations, the one or more data validation rules may identify techniques for describing errors identified in preliminary analysis in greater detail or for revising errors identified in preliminary analysis. For instance, an error identified in preliminary analysis may be assigned to a broad category, such as “Invalid Address”. Then, the data validation rules may provide instructions for identifying particular problems with an address, such as “illegible address” or “missing street number”.

According to various embodiments, a validation rule may include a field that identifies a type of preliminary error. For instance, the validation rule may identify an error as being a problem with an address, name, or social security number field of a document data record.

In some implementations, a validation rule may include an error relationship field that identifies a relationship between a preliminary error and one or more potentially more detailed errors. For instance, the relationship field may identify the relationships as one-to-one, many-to-one, parse, ignore, enhanced, new.

For example, “one-to-one” validation rules may map a single preliminary error to a single advanced error. “Many-to-one” data validation rules may map potentially more than one preliminary error to a single advanced error. “Ignore” validation rules may identify preliminary errors that were incorrectly identified as errors. “New” errors may identify error conditions that are unrelated to those identified via the preliminary error analysis.

“Enhanced” validation rules may identify preliminary errors that can be elaborated based on additional information. For instance, in an I-9 Form, the Work Authorization Status may be a required field. If no selection is indicated, the error may be flagged in one way. If instead more than one box is checked or too much information is entered (e.g., both an admission and alien number written in, or an expiration date for an Alien number), the error may be flagged in a different way.

A “parse” validation rule may indicate additional actions that may be performed after parsing the information identified as erroneous. For instance, one error may identify an invalid social security number. If a social security number is present but is not nine digits, then the error may be flagged as an invalid social security number. If instead a 9-digit social security number is present but does not match the social security number entered in a different section of the form, the error may be further identified as a social security number mismatch.

At 406, the selected error is evaluated based on the identified validation rules. Evaluating the selected error based on the identified validation rules may involve determining a mapping from the preliminary errors to more specific errors via the rules. When evaluating a rule identified via preliminary analysis, a determination may be made as to which course of action to adopt.

For example, a preliminary error may be accepted as a correct description of an error condition. As another example, a preliminary error may be rejected as being incorrectly identified as an error. As yet another example, two preliminary errors may be collapsed into a single advanced error. As still another example, business rules or business logic may be applied to parse a preliminary error into one or more advanced errors.

In some implementations, business rules or business logic may be used to perform various types of additional data analysis. For instance, data analysis may be performed to improve error identification, frequency, accuracy, classification, and/or other characteristics.

In one example of business logic, preliminary error analysis may identify an error as “DTPROB, #5”, corresponding to one or more errors in one or more date fields of an I-9 Form. However, business logic may be used to elaborate the date error based on information included in the data record. For instance, when “DTPROB, #5” exists in the preliminary error analysis results, the error resolution engine may examine various data fields and apply business rules and logic to parse the preliminary error into any of four distinct advanced errors or ignore the preliminary error.

In this example, the “DTPROB, #5” preliminary error may correspond to various types of advanced errors. If a date of birth indicating that an employee was younger than 14 years of age at the employment, the start date may be flagged as an “underage” error since this age may be in violation of state employment laws. If the start date is in the future when error analysis is performed, then the start date may be flagged as a “future start date” error. If either the Section 1 Signature date or the Section 2 Signature date fields are out of compliance based on the start date, these errors may be flagged separately. Finally, if none of these conditions are met, then the preliminary error may be ignored as having been created erroneously.

At 408, a determination is made as to whether to select an additional error for resolution. According to various embodiments, some or all of the errors identified via preliminary analysis may be evaluated via the method 400. In some instances, the method 400 may be performed in order to evaluate preliminary errors identified for each document record created within the document record management system.

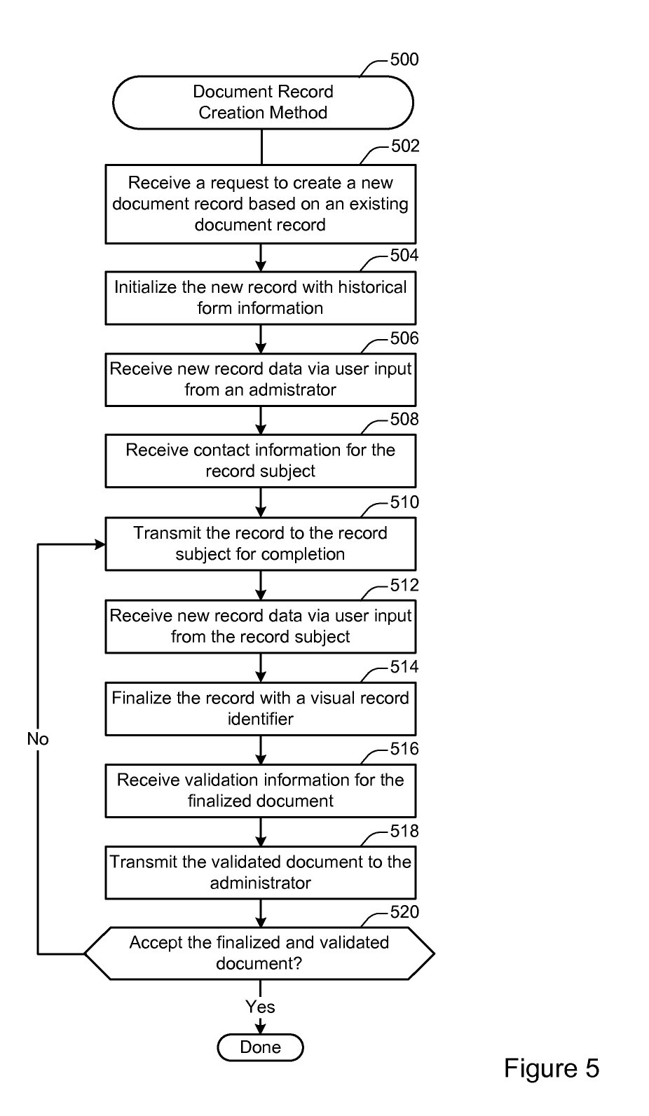

FIG. 5 illustrates an example of a document record creation method 500, performed in accordance with one or more embodiments. At 502, a request is received to create a new document record based on an existing document record. According to various embodiments, the request may be received when it is determined that an existing document record is unfixable. For example, a user such as an administrator may initiate the request. As another example, a record analysis system may determine that an existing document record includes errors that cannot be remedied, and that a new record needs to be created.

In particular embodiments, the request may be created when a document record validation method determines that the document contains one or more irremediable errors. For instance, the request may be generated when a determination is made at operation 214 that the errors cannot be resolved. The validated data may be stored at operation 218 for retrieval as historical form information in method 500.

At 504, the new record is initialized with historical form information. According to various embodiments, the historical form information may include any data that is salvageable from the historical form. For instance, the historical form may include a subject's name, start date, or other such data. This information may be retrieved from a storage location such as a database and added to the new form record.

At 506, new record data is received via user input from an administrator. According to various embodiments, the new record data may include any information available to the administrator that is not yet already included and correct in the information retrieved from the historical form information. For instance, the new record data may include an employee's birth date, address, or other such data.

At 508, contact information for the record subject is received. According to various embodiments, the contact information may be any information that may be used to transmit the incomplete record to the record subject for completion. For instance, the contact information may be an email address, a user account identifier, a physical address, or other suitable contact information. The contact information may be provided manually via user input, for instance by the administrator, or may be retrieved electronically from a storage location.

At 510, the record is transmitted to the record subject for completion. According to various embodiments, the record may be transmitted via any suitable means, such as via email or postal mail. In some instances, the record itself need not be transmitted. Instead, a Uniform Resource Indicator (URI) that leads to the record may be transmitted. The record may be transmitted in such a way that the record subject may access the record to complete it.

At 512, new record data is received via user input from the record subject. According to various embodiments, the new record data may be any information necessary to complete the record that was not accurately provided by either retrieving the historical form information or receiving user input from the administrator. For instance, the new record data may include information that was missing in the original historical record and that the administrator does not possess.

At 514, the record is finalized with a visual record identifier. According to various embodiments, the visual record identifier may be a one-dimensional barcode, a two-dimensional barcode, an identification number, or any other suitable marker for digitally identifying the record. The record may be finalized by printing the record with the visual record identifier or finalizing the record by reducing it from an editable document to a digital image that includes the visual record identifier.

At 516, validation information for the finalized document is received. According to various embodiments, the validation information may include information from a credible validation source such as a notary public, a public official, an employee representative, or another such individual. The validation may be received via digital or non-digital means. For instance, the validation may include an electronic or non-electronic signature, date, stamp, and/or any other suitable validation. The validation may be provided after the validation source has provided suitable identifying information such as a driver's license, passport, social security card, or other such documentation.

At 518, the validated document is transmitted to the administrator. According to various embodiments, the validated document may be transmitted in such a way that the validated document may be associated with the record. For example, the validated document may be mailed via physical mail and then scanned. As another example, the validated document may be scanned and emailed.

In some implementations, transmitting the validated document may involve receiving the validated document at a record management system. When received, the validated document may be analyzed to identify the visual record identifier. The visual record identifier on the transmitted document may be compared with visual record identifiers associated with document records to identify the document record associated with the document. For instance, visual record identifiers may be associated with a stored document record as a hash value or some other suitable unique identifier that may be compared with the identifier on the physical or digital document copy.

When the document record associated with the physical or digital document copy is identified, a digital copy of the document may be stored in associated with the document record. Then, the document record may be supplemented with information indicating that the record has been verified.

At 520, a determination is made as to whether to accept the finalized and validated document. According to various embodiments, the determination made at operation 520 may be made manually, automatically, or some combination thereof. For example, the document analysis system may analyze the historical form information provided at 504, the new record data provided via user input from the administrator at 506, and the new record data provided via user input from the record subject at 512 to determine whether the document record meets the requirements for a valid document record. For instance, the document record may be validated via the document record data validation method 200 shown in FIG. 2.

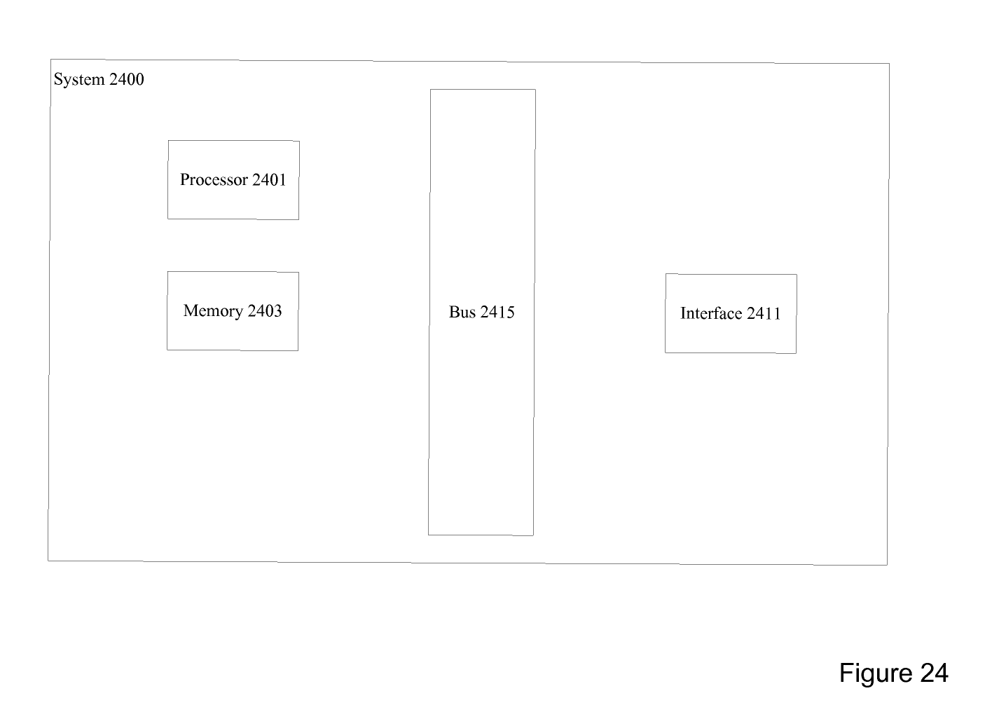

FIG. 24 illustrates one example of a server. According to particular embodiments, a system 2400 suitable for implementing particular embodiments of the present invention includes a processor 2401, a memory 2403, an interface 2411, and a bus 2415 (e.g., a PCI bus or other interconnection fabric) and operates as a document resolution system. When acting under the control of appropriate software or firmware, the processor 2401 is responsible for performing tasks such as document record data validation and error resolution. Various specially configured devices can also be used in place of a processor 2401 or in addition to processor 2401. The interface 2411 is typically configured to send and receive data packets or data segments over a network.

Particular examples of interfaces supported include Ethernet interfaces, frame relay interfaces, cable interfaces, DSL interfaces, token ring interfaces, and the like. In addition, various very high-speed interfaces may be provided such as fast Ethernet interfaces, Gigabit Ethernet interfaces, ATM interfaces, HSSI interfaces, POS interfaces, FDDI interfaces and the like. Generally, these interfaces may include ports appropriate for communication with the appropriate media. In some cases, they may also include an independent processor and, in some instances, volatile RAM. The independent processors may control communications-intensive tasks such as packet switching. Although a particular server is described, it should be recognized that a variety of alternative configurations are possible.

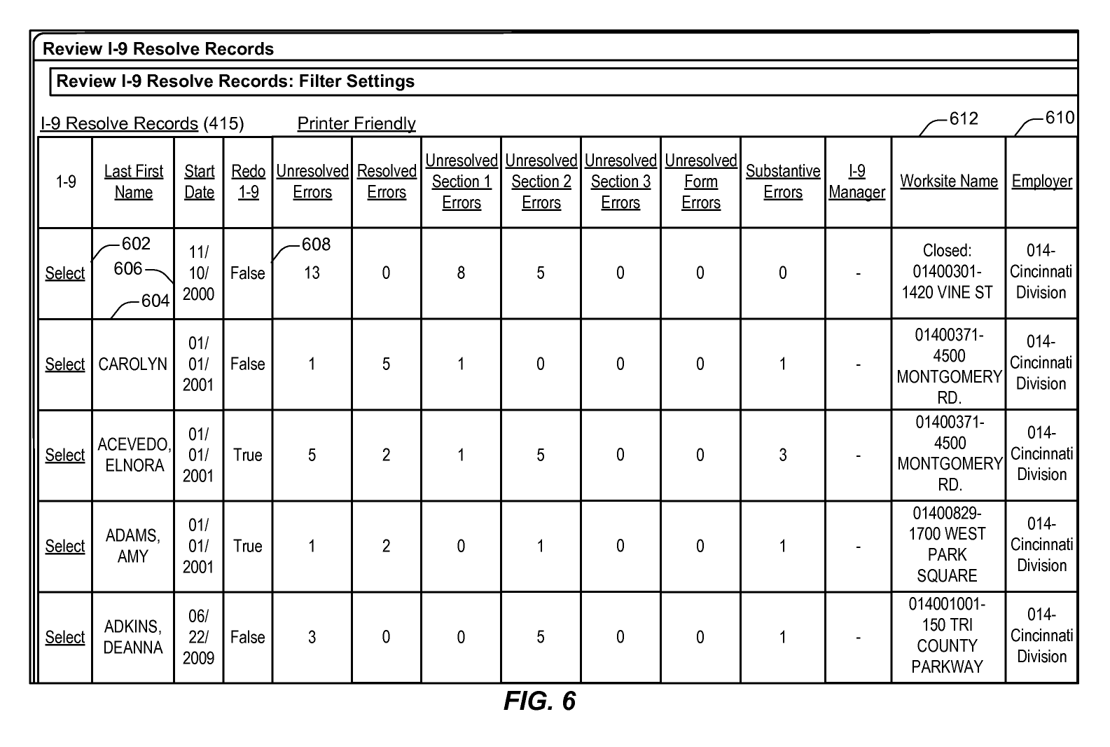

FIGS. 6-23 illustrate various user interfaces that may be presented in accordance with techniques and mechanisms described herein.

According to various embodiments, users may access and use a system for resolving document form errors in various ways. For instance, a user may first log in to the system in order to identify the individual responsible for changes to I-9 forms and to verify that the user is authorized to access information and make changes. The login process may be performed, for example, through an Internet browser or via integration with other types of applications.

According to various embodiments, a user may be presented with a home screen that contains navigation links for creating and viewing document records, as well as links to view reports. Summary modules may be displayed, helping users to quickly view risk exposure. The user may be presented with a summary of document records such as I-9 Form records for which the user is responsible.

In some implementations, the user may navigate to a document record by searching for a document record, by selecting a category from a task summary widget, by selecting a link leading to a record resolution interface, or via a different navigation technique.

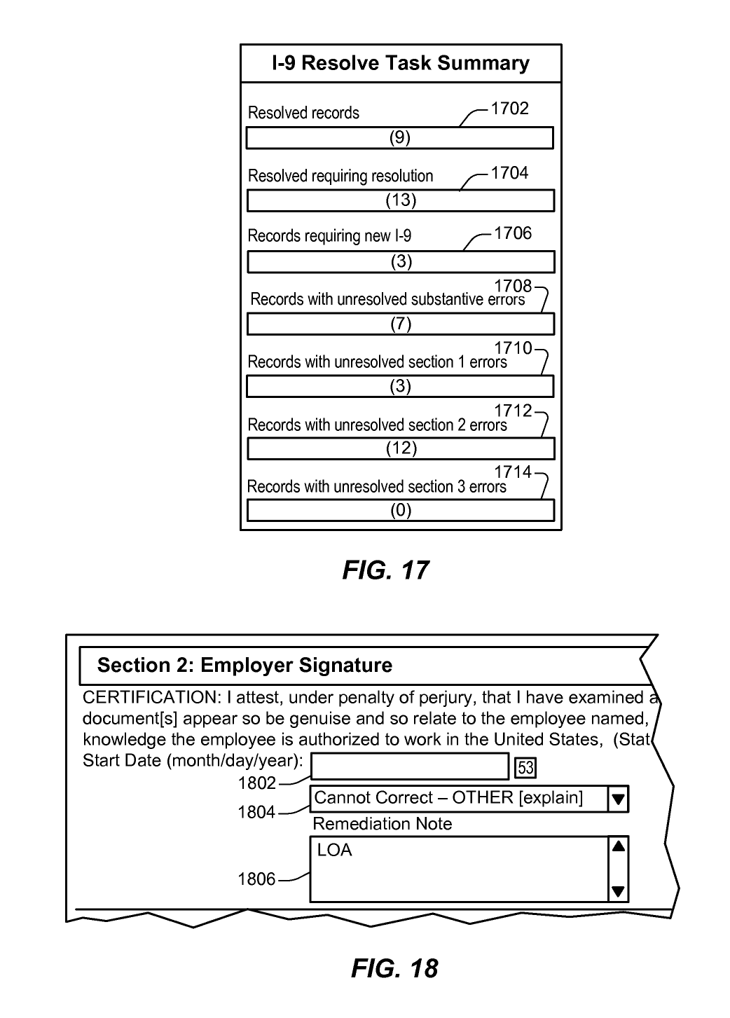

In some embodiments, an I-9 resolve task summary widget, as shown in FIG. 17, may provide an overview of records in need of resolution and/or provide a way to access those records. For instance, the bars in the widget may provide clickable links that may be used to access the records. The bars shown in FIG. 17 may provide direct access to I-9 Form records that correspond to different types of error categories, including form records that have been resolved 1702, form records that require resolution 1704, and form records that have different types of errors. Records with errors may include records requiring a new I-9 1706, records with unresolved substantive errors 1708, records with unresolved section 1 errors 1710, records with unresolved section 1 errors 1712, and records with unresolved section 3 errors 1714,

According to various embodiments, a form record may be associated with various types of errors. For example, a substantive error may reflect a determination that the content of the information included in the record is erroneous. For instance, a Certificate of Naturalization may not be considered a valid document type for a particular type of document record such as an I-9 form. If such a document type is listed on the form, then the error may be treated as substantive.

As another example, a technical error may be an instance where information had been input incorrectly. For instance, an element of an address may be missing form an address field on an I-9 from, such as city or state. In this case, the missing address element is an error that may be treated as technical.

In some implementations, records may be located via a search function. For instance, a record associated with an employee may be located by searching for the employee's name, social security number, employee ID, note field, external worksite ID, or any other type of information associated with a record.

In some implementations, records may be sorted and filtered via a user interface. For instance, records may be listed in a user interface as shown in FIG. 6. In the table-like interface shown in FIG. 6, a user may sort the report by the contents of a column, for instance by clicking on the column's header. A user may access a record listed in the report by clicking a link such as “select” at 602. Each line may provide indication about the record, such as the employee's name at 604, and whether the associated I-9 needs to be re-done at 606. As well, each line may identify the employer at 610, the worksite name at 612, and error counts for one or more types of errors that may be associated with a record.

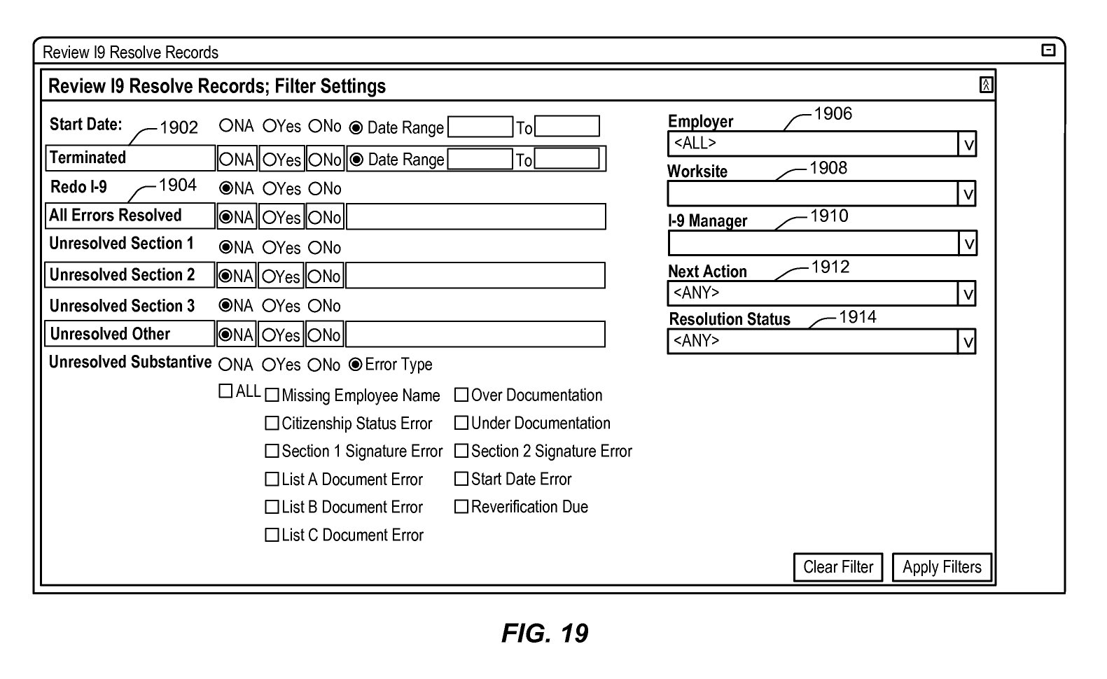

Alternately, or additionally, a user may provide one or more filter conditions such as a termination date range and a type of error for use in creating a custom report. An example of a user interface for creating a custom report is shown in FIG. 19. For instance, in FIG. 19 a user may select records based on fields such as a termination status of the employee at component 1902, whether all errors associated with the record have been resolved at component 1904, an employer identity at component 1906, a worksite at component 1908, an I-9 manager at component 1910, a next action to take at component 1912, and a resolution status of the record at component 1914.

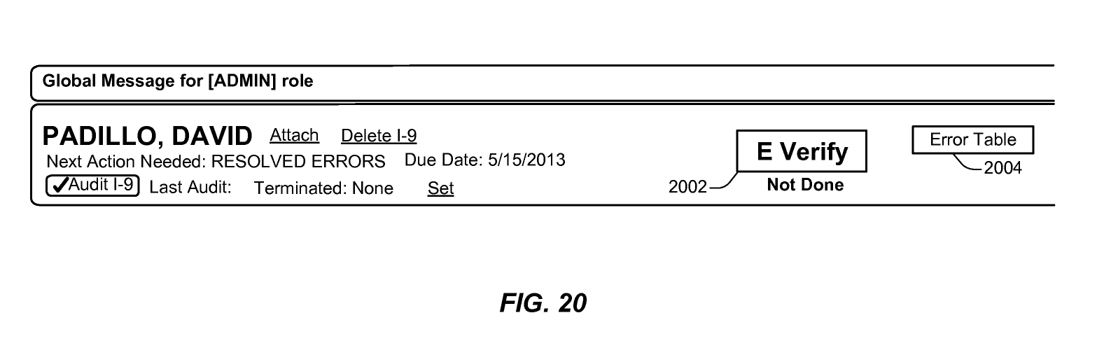

According to various embodiments, when a record is selected, a banner containing information relevant to the employee may be presented. An example of such a banner is presented in FIG. 20. The banner may provide various options such as electronically verifying the information at 2002 and retrieving an error table for the record at 2004. The banner may also indicate the employee's name as well as the next actions that need to be taken to complete the record.

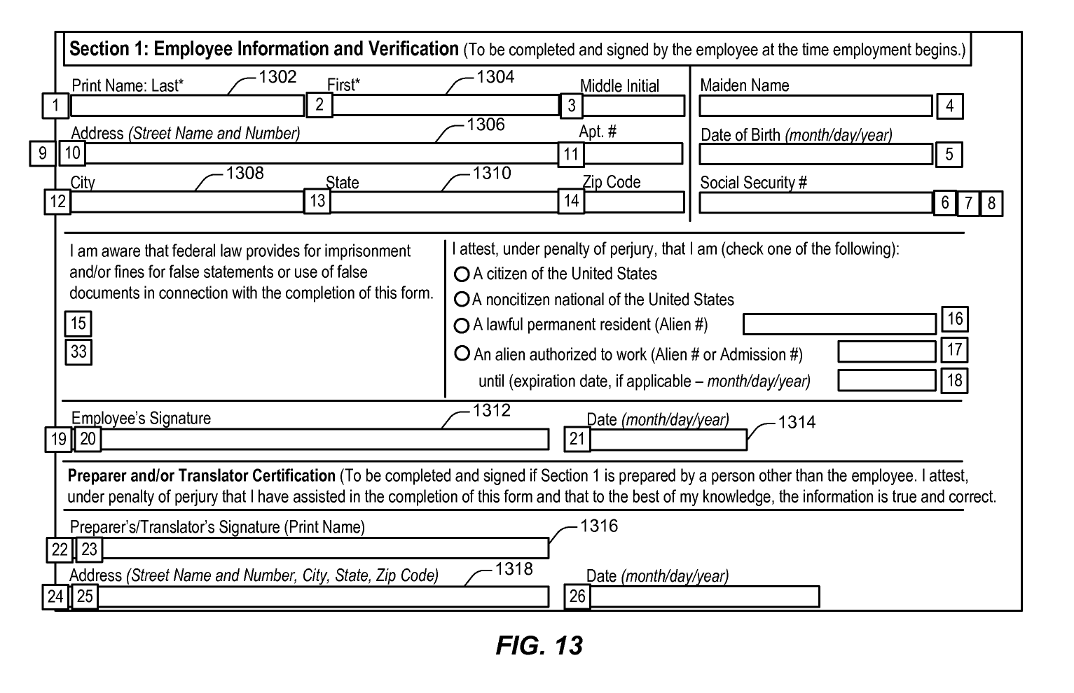

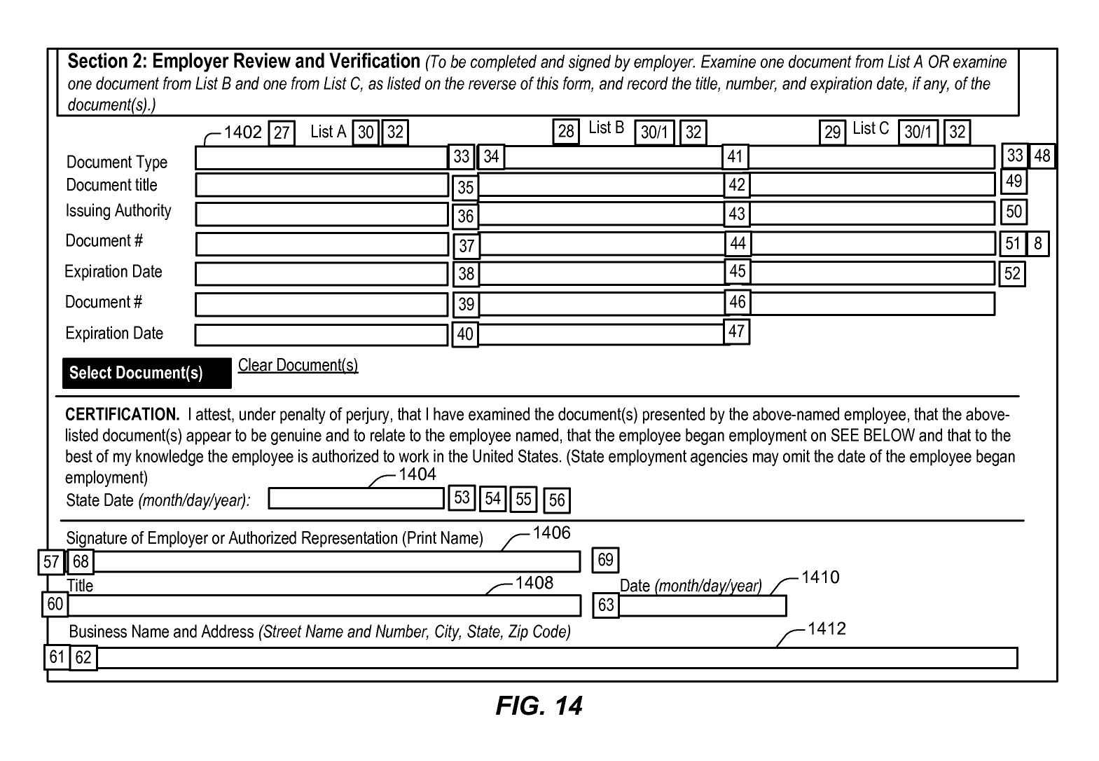

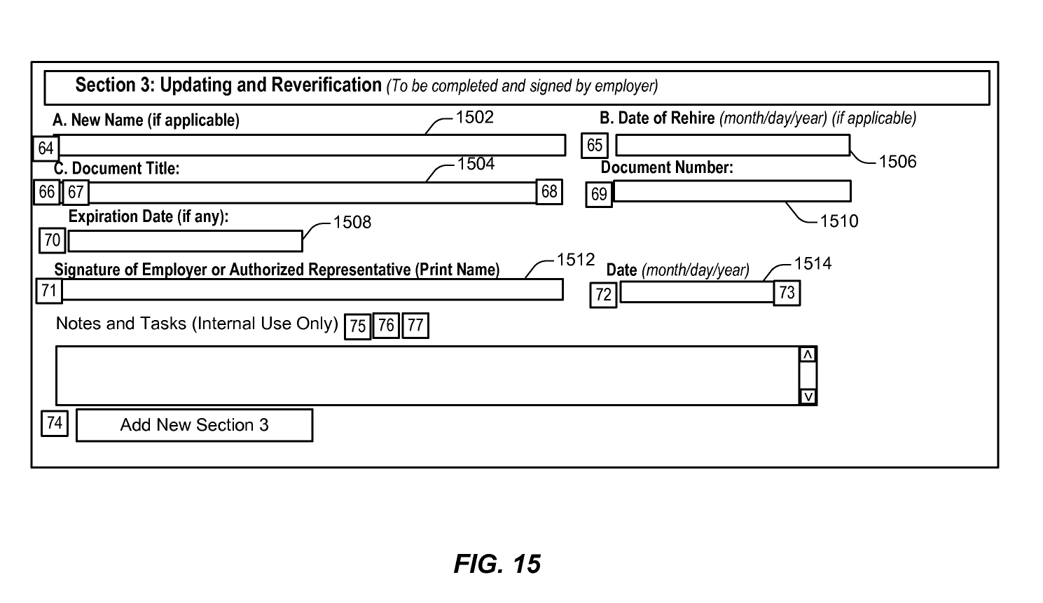

FIGS. 13-15 illustrate examples of user interfaces for providing information for different sections of a form record, in this case an I-9 form record. For instance, FIG. 13 facilitates the receipt of user input for Section 1 of an I-9 form, FIG. 14 facilitates the receipt of user input for Section 2 of an I-9 form, and FIG. 15 facilitates the receipt of user input for Section 3 of an I-9 form.

FIG. 13 includes various user interface components for receiving employee information. For example, the employee's name may be provided at components 1302 and 1304, the employee's address may be provided at components such as 1306, 1308, and 1310. The employee's signature and date of signature may be provided at components 1312 and 1314. The preparer's signature and address may be provided at components 1316 and 1318.

FIG. 14 also includes various user interface components for receiving employee information. For example, information related to document used to verify an employee's information may be provided at components such as 1402. The employee representative completing the form may certify document authenticity by providing a date at component 1404, a signature at component 1406, a title at component 1408, a signature date at component 1410, and a business name at component 1412.

FIG. 15 also includes various user interface components for receiving employee information. For instance, a new name for an employee may be provided at component 1502, a date of rehire at component 1504, a document title at component 1506, document information at components 1508 and 1510, and employer representative signature and date information at components 1512 and 1514.

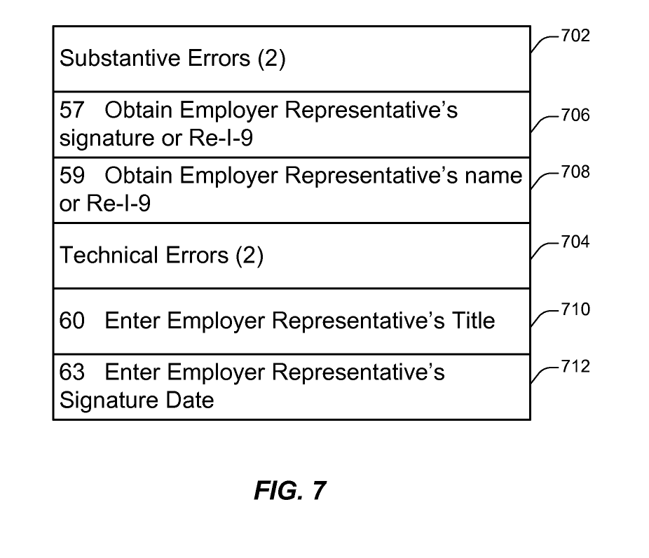

According to various embodiments, a user interface component such as the one shown in FIG. 7 may list one or more types of errors associated with a document form. The errors shown in FIG. 7 are divided into substantive errors 702 and technical errors 704.

Substantive errors may include those that relate to the fundamental correctness or completeness of the form, such as a failure to obtain the name 706 or signature 708 of the employer representative completing the form. Technical errors may include those that relate to inconsistencies or informalities, such as a failure to enter a title 710 or a signature date 712 for the employer representative completing the form.

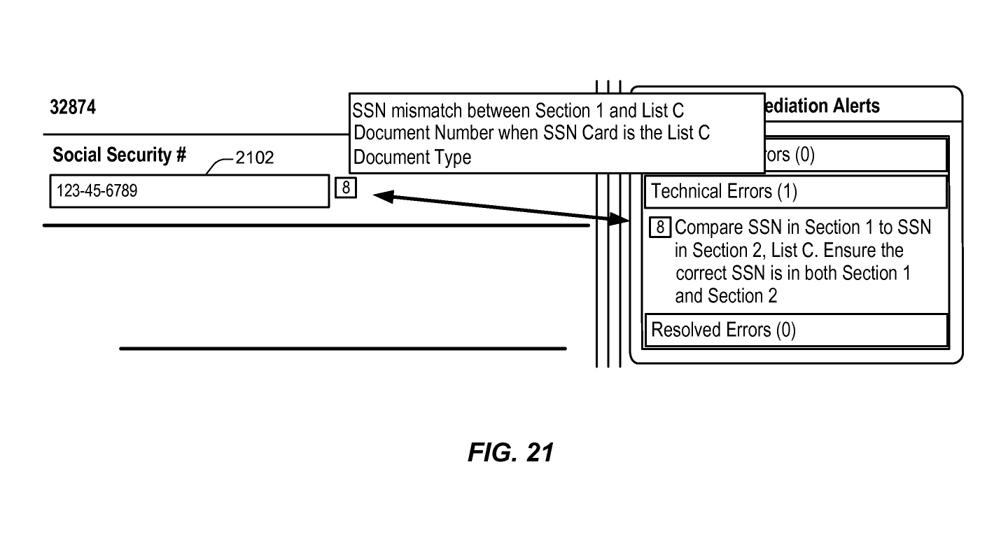

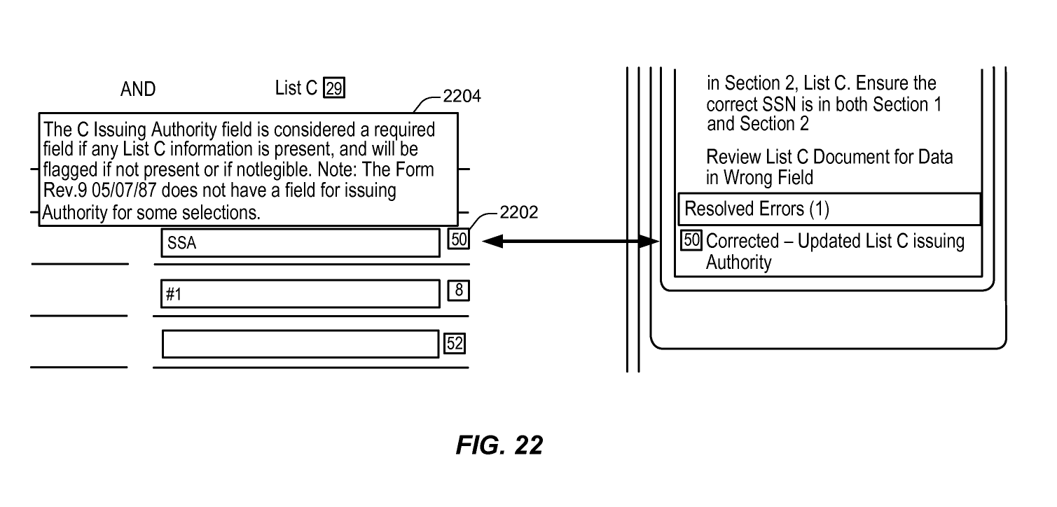

For instance, FIG. 21 illustrates a user interface that identifies a technical error corresponding with a mismatched social security number and that highlights the inconsistent field at component 2102. FIG. 22 illustrates a user interface that highlights the number of an error that has been resolved at component 2202. Also, additional information regarding why a field has been flagged as erroneous is presented in a popup window at 2204 that appears when hovering with a mouse pointer over the erroneous field or the error.

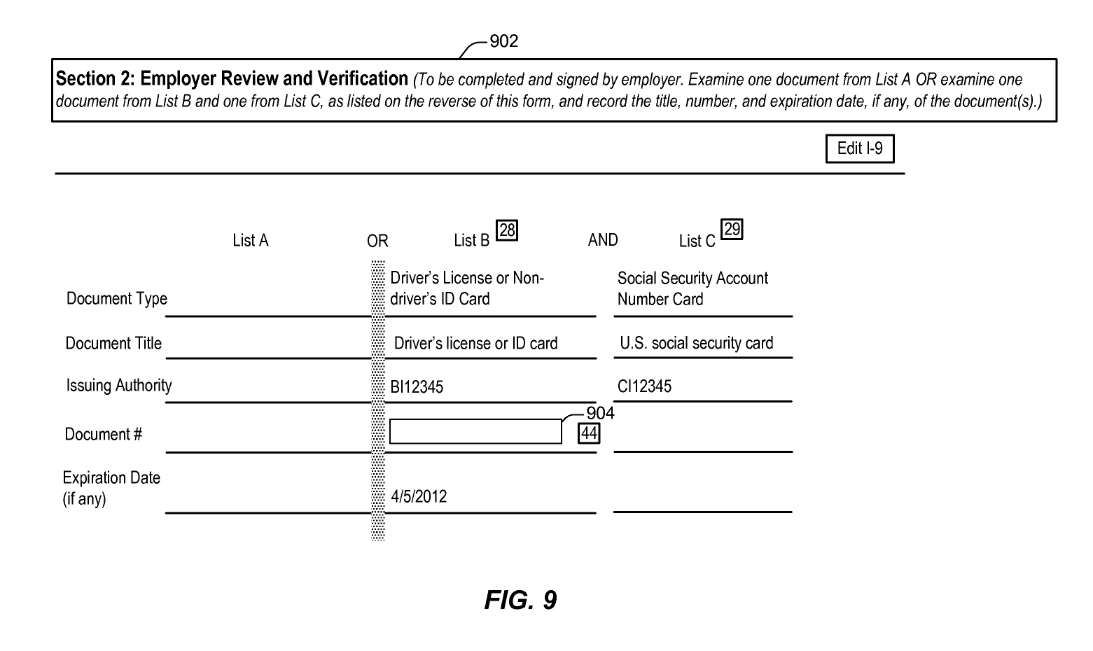

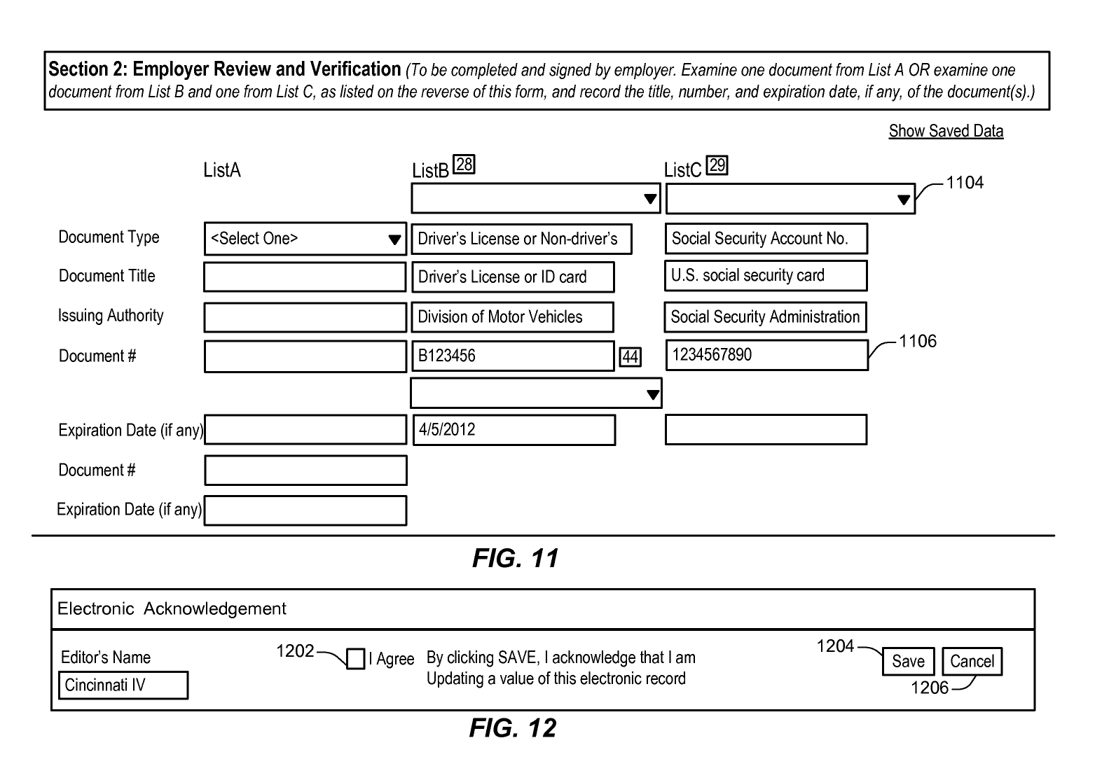

FIGS. 9-12 illustrate user interfaces that may be used to resolve errors in forms. For instance, in FIGS. 9 and 11, text fields associated with an I-9 Form record are entered. In FIG. 9, instructions for completing the form are provided at 902. A text box at 904 allows a user to enter information for a missing field in the record.

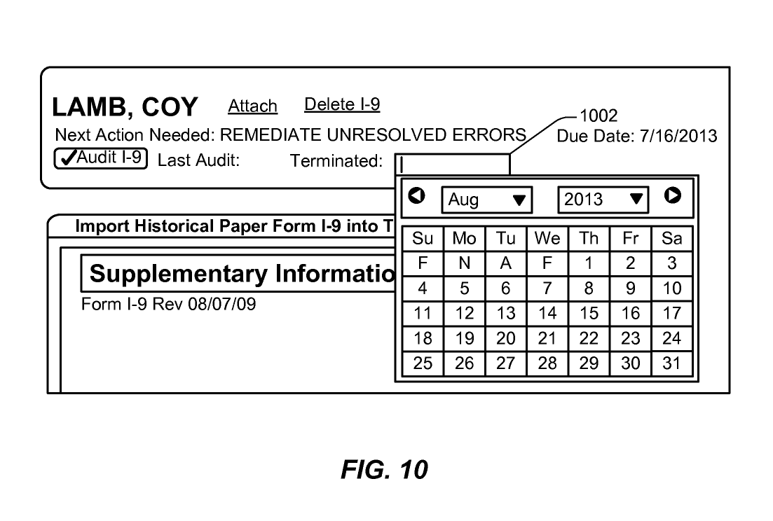

In FIG. 10, a termination date associated with an employee may be provided in the text box at 1002. In some implementations, marking an employee as terminated may require entering a termination date from a payroll system. For instance, the system may communicate with the payroll system to ensure that the same date is used on both systems.

In FIG. 11, a user may enter information associated with a record. For instance, the user may select a document type at 1104 and enter a document number at 1106.

In FIG. 12, a manager responsible for a change to a form record may indicate agreement with the modifications. For instance, the manager may indicate agreement at 1202, save changes at 1204, or cancel changes at 1206

In some embodiments, when editing a form record, users may be presented with a screen that displays previously saved values. The previously saved values may be grayed out and/or not editable. They may be displayed as a reference for the user when entering new values in nearby editable fields. In this way, both previous and updated information for a form field may be saved, and information that is not erroneous may be protected.

In some implementations, users with appropriate permissions may edit fields that are uneditable to other users. For example, a manager may be authorized to edit fields that do not contain errors. In some instances, errors may be corrected in this way resolving information that is not consistent. For example, a historical form may indicate that a user's name is John, while in digital form the user's name may be listed as Jon. Using the edit function, this typographical error may be corrected.

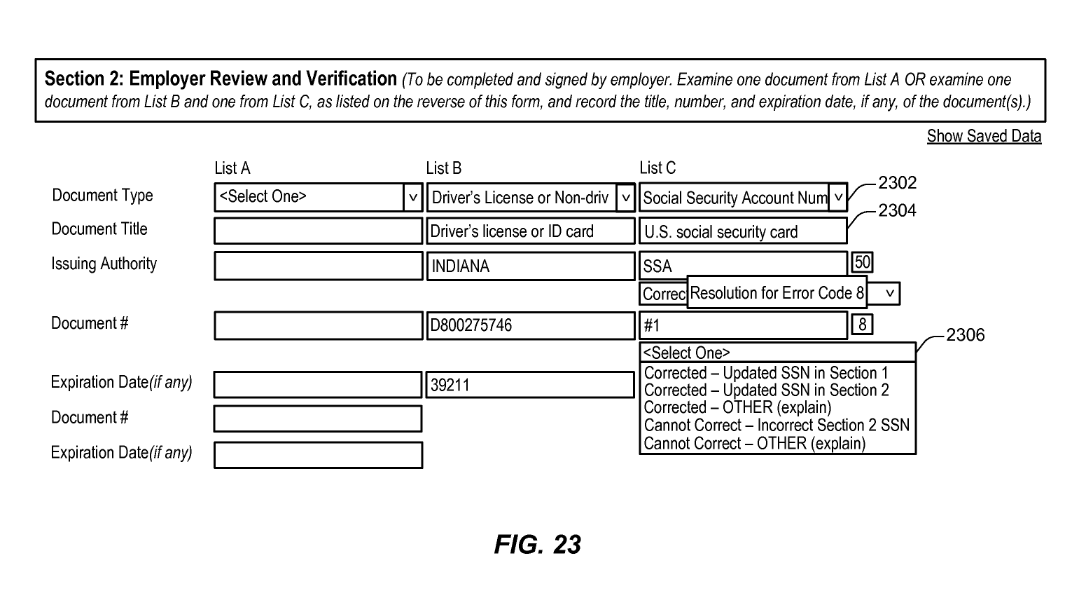

FIG. 23 illustrates an example of a user interface for resolving an error. The user may provide information to resolve the error at components such as 2302 and 2304. The user is presented with a drop-down box at 2306 that allows the user to select from among a set of actions for remediation. For instance, in FIG. 23, the user may reconcile the social security number with one provided in a different section of the document, may indicate that the error cannot be corrected, or perform other such actions.

According to various embodiments, a new form record may be created for a new employee or when a historical form for an existing or past employee cannot be resolved. For example, a record may be impossible to fix or an error may be impossible to resolve when an employee has left a company and is no longer available to sign a document or provide information. As another example, a record may contain a fundamental error such as an employee signature that is provided after the employee's start date. As yet another example, attempts to identify correct information to resolve an error may be unsuccessful.

In some instances, an error cannot be fixed. For instance, an employee may be required to sign an I-9 Form but may be unable to sign due to being on a leave of absence. FIG. 18 illustrates a user interface for providing a remediation note for providing information such as how an error was resolved or why remediation was not possible.

In FIG. 18, the field at which there is an error is shown at 1802. The user interface component shown at 1804 may allow a user to select an explanation category for the error. A text note field allowing a user to provide further explanation is shown at 1806.

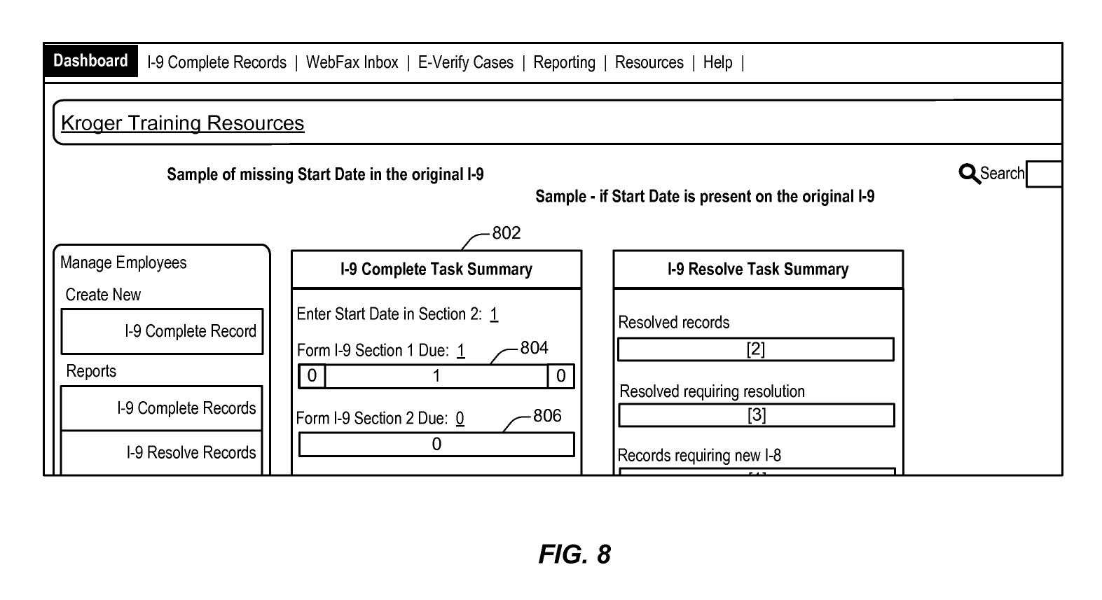

In FIG. 8, a new I-9 Form record is created based on information retrieved from a historical I-9 Form. In this way, a user completing the new form record need only supply information that is missing or otherwise erroneous on the historical form. New forms created in this way may be linked to the historical record to maintain a record of actions related to the I-9 Form.

For instance, in FIG. 8 the user interface component 802 shows the tasks that need to be completed in order to create a new I-9 Form record. The user interface component 804 indicates that Section 1 of the form needs to be completed. The user interface component 806 indicates that Section 2 of the form does not need to be completed since it was imported from the original I-9 Form record.

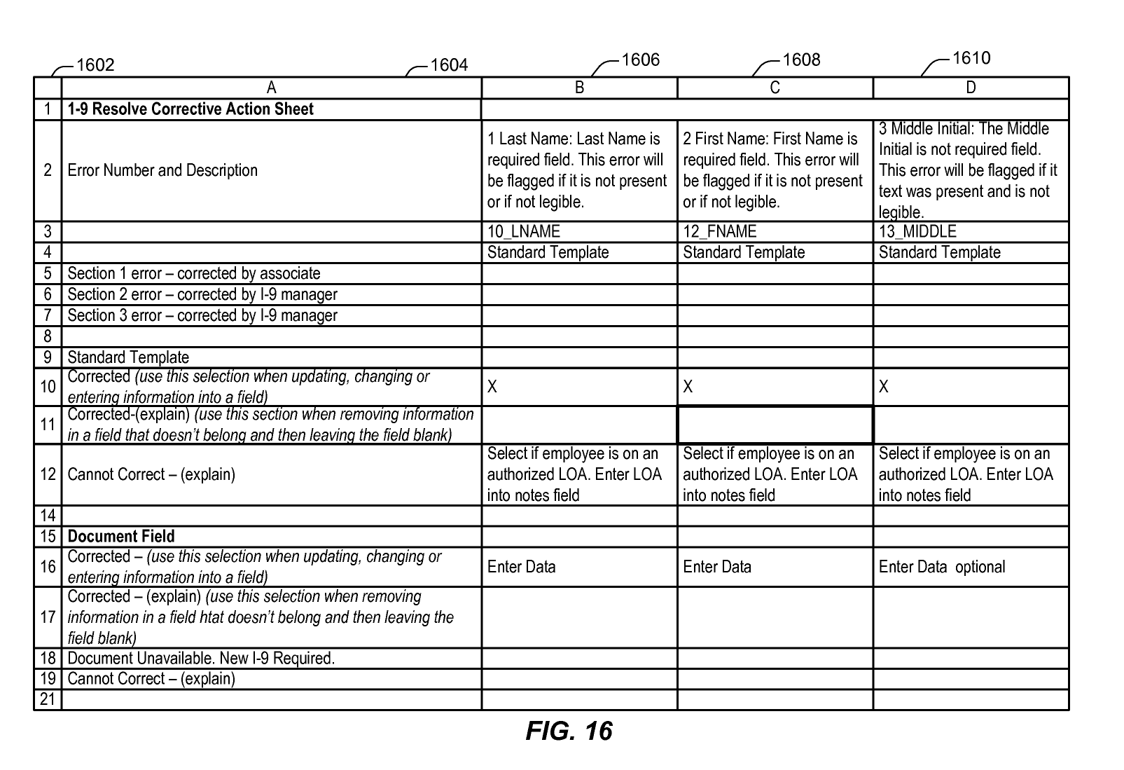

According to various embodiments, various rules may be used to identify and/or resolve errors. For instance, FIG. 16 illustrates an example of a corrective action sheet. According to various embodiments, the corrective action sheet may provide rules for automatically and/or manually resolving errors that may occur in a form such as an I-9 Form document.

For example, the column 1604 lists various fields that may be entered for different errors, while the column 1602 lists the field number. Column B 1606, Column C 1608, and Column D 1610 list different errors that may occur. Of course, various implementations may include any number of possible errors that may occur, along with information about whether and how they may be corrected.

The error described in Column B is a missing or invalid Last Name. The column indicates that the error cannot be corrected if an employee is on an authorized leave of absence. The column is also capable of indicating other information, such as who may correct an error, whether the error

According to various embodiments, a user may enter information for overriding errors or inserting new errors. For instance, authorized users may have access to an error table that includes a matrix indicating different error types within a section and that allows errors to be added, modified, activated, deactivated, or otherwise altered. Then, existing records may be reanalyzed under the new error analysis scheme.

In some implementations, different users may be assigned different permissions. For instance, some users may be authorized to correct errors, while other users may be authorized to perform other management functions such as editing existing data.

Although many of the components and processes are described above in the singular for convenience, it will be appreciated by one of skill in the art that multiple components and repeated processes can also be used to practice the techniques of the present invention.

While the invention has been particularly shown and described with reference to specific embodiments thereof, it will be understood by those skilled in the art that changes in the form and details of the disclosed embodiments may be made without departing from the spirit or scope of the invention. It is therefore intended that the invention be interpreted to include all variations and equivalents that fall within the true spirit and scope of the present invention.

1. A method comprising:
identifying via a computer processor one or more errors in existing document record data associated with an existing document record, the existing document record associated with a digital image of a physical document, the existing document record associated with one or more document restrictions;
determining replacement data for resolving one or more of the identified errors; and
storing the replacement data on a storage medium.

2. The method recited in claim 1, the method further comprising:
scanning a physical document to create the digital image.

3. The method recited in claim 2, the method further comprising:
performing optical character recognition on the digital image to identify the existing document record data.

4. The method recited in claim 1, wherein the document record corresponds with an official government record.

5. The method recited in claim 4, wherein the official government record is an Employment Eligibility Verification Form I-9 provided by United States Citizenship and Immigration Services.

6. The method recited in claim 1, wherein identifying the one or more errors in the existing document record data comprises applying a plurality of data validation rules to the existing document record data, the data validation rules capable of being used to indicate one or more violations of the document restrictions.

7. The method recited in claim 1, the method further comprising:
determining that the document record is not remediable; and
creating a new document record, the new document record including at least a portion of the existing document record data, the new document record further including the replacement data.

8. The method recited in claim 7, the method further comprising:
associated the document record with a unique visual record identifier; and
transmitting the document record to the document subject for completion.

9. The method recited in claim 8, the method further comprising:
receiving a completed document from the document subject, the completed document including the unique visual record identifier; and
associated the completed document with the document record based on the visual record identifier.

10. The method recited in claim 1, wherein determining replacement data comprises:
receiving user input to resolve one or more of the identified errors, and associating the received user input with a user account.

11. A system comprising:
a document record processor operable to identify one or more errors in existing document record data associated with an existing document record, the existing document record associated with a digital image of a physical document, the existing document record associated with one or more document restrictions;
a document error resolver operable to determine replacement data for resolving one or more of the identified errors; and
a storage medium operable to store the replacement data.

12. The system recited in claim 11, wherein the document record corresponds to an Employment Eligibility Verification Form I-9 provided by United States Citizenship and Immigration Services.

13. The system recited in claim 11, wherein identifying the one or more errors in the existing document record data comprises applying a plurality of data validation rules to the existing document record data, the data validation rules capable of being used to indicate one or more violations of the document restrictions.

14. The system recited in claim 11, wherein the processor is further operable to:
determine that the document record is not remediable; and
create a new document record, the new document record including at least a portion of the existing document record data, the new document record further including the replacement data.

15. The system recited in claim 14, wherein the processor is further operable to:
associate the document record with a unique visual record identifier; and
transmit the document record to the document subject for completion.

16. One or more computer readable media having instructions stored thereon for performing a method, the method comprising:
identifying via a computer processor one or more errors in existing document record data associated with an existing document record, the existing document record associated with a digital image of a physical document, the existing document record associated with one or more document restrictions;
determining replacement data for resolving one or more of the identified errors; and
storing the replacement data on a storage medium.

17. The one or more computer readable media recited in claim 16, the method further comprising:
scanning a physical document to create the digital image.

18. The one or more computer readable media recited in claim 17, the method further comprising:
performing optical character recognition on the digital image to identify the existing document record data.

19. The one or more computer readable media recited in claim 16, wherein the document record corresponds with an Employment Eligibility Verification Form I-9 provided by United States Citizenship and Immigration Services.

20. The one or more computer readable media recited in claim 16, wherein identifying the one or more errors in the existing document record data comprises applying a plurality of data validation rules to the existing document record data, the data validation rules capable of being used to indicate one or more violations of the document restrictions.
